(19) United States
(12) Patent Application Publication
(10) Pub. No.: US 2015/0084468 A1
(43) Pub. Date: Mar. 26, 2015

(54) ROTOR FOR PERMANENT-MAGNET-EMBEDDED ELECTRIC MOTOR, ELECTRIC MOTOR INCLUDING THE ROTOR, COMPRESSOR INCLUDING THE ELECTRIC MOTOR, AND AIR CONDITIONER INCLUDING THE COMPRESSOR

(71) Applicants: Masahiro Nigo, Tokyo (JP); Kazuhiko Baba, Tokyo (JP); Kazuchika Tsuchida, Tokyo (JP)

(72) Inventors: Masahiro Nigo, Tokyo (JP); Kazuhiko Baba, Tokyo (JP); Kazuchika Tsuchida, Tokyo (JP)

(73) Assignee: MITSUBISHI ELECTRIC CORPORATION, Tokyo (JP)

(21) Appl. No.: 14/371,189

(22) PCT Filed: Jan. 30, 2012
(86) PCT No.: PCT/JP2012/052028

§ 371 Date: Jul. 9, 2014

(51) Int. Cl. H02K 1/27

(52) U.S. Cl. CPC H02K 1/276
USPC 310/156.53

(57) ABSTRACT

A rotor for a permanent-magnet-embedded electric motor includes slit holes each axially formed near opposite ends of a magnetic pole between an outer peripheral face of a rotor core and a magnet insertion hole, and forming a symmetrical shape in an approximately truncated chevron shape along the outer peripheral face of the rotor core, based on a centerline of each of the magnetic poles, wherein a thickness of each of permanent magnets is set to be twice or more of an air gap, a width of a shortest magnetic path in which a distance between the slit hole and the permanent magnet becomes shortest is set to be twice or more of the air gap, and an inclination of the slit hole with respect to a width direction of the permanent magnet orthogonal to a radial direction is set to be in a range from 0 to 30 degrees.

### CROSS REFERENCE TO RELATED APPLICATION

This application is a U.S. national stage application of PCT/JP2012/052028 filed on Jan. 30, 2012, the contents of which are incorporated herein by reference.

### TECHNICAL FIELD

The present invention relates to a rotor for a permanent-magnet-embedded electric motor, an electric motor including the rotor, a compressor including the electric motor, and an air conditioner including the compressor.

### BACKGROUND

An electric motor mounted on a compressor of an air conditioner needs to achieve energy saving and noise reduction, and needs to ensure use in a high-temperature atmosphere of 150° C. Generally, a Nd—Fe—B (neodymium-iron-boron) rare-earth magnet has a high residual magnetic flux density and is suitable for achieving downsizing and high efficiency of an electric motor. However, a coercive force decreases as the temperature increases. Therefore, when comparison is made under a same electric current condition, as the electric motor is used in a high-temperature atmosphere, the electric motor is likely to be demagnetized. Accordingly, the coercive force is improved so as not to be demagnetized by adding a heavy rare-earth element, for example, Dy (dysprosium) or Tb (terbium), so that the rare-earth magnet is not demagnetized in a high-temperature atmosphere. However, recently, since a heavy rare-earth element is rare and highly valued, there is an increasing risk of procurement and price increase. In view of such circumstances, there is a demand for an electric motor having high efficiency, reduced noise, and high resistance to demagnetization that can be used without being demagnetized even with a rare-earth magnet having a low coercive force.

Conventionally, for example, there has been disclosed a technique for acquiring a highly efficient permanent-magnet electric motor with less noise and vibration by reducing reaction magnetic flux of an armature and improving magnetic flux distribution in an iron core on an outer circumference. According to this technique, the electric motor includes a rotor core obtained by laminating steel plates in a columnar shape as a whole, a permanent-magnet housing hole formed at a portion corresponding to each side of an approximately regular polygon in the rotor core, centered on a shaft center of the rotor core, a permanent magnet respectively inserted into the permanent-magnet housing hole, and four or more slit holes formed in the iron core on an outer circumference of the permanent-magnet housing hole, having an elongated shape in a radial direction, and arranged away from each other along the permanent-magnet housing hole. A pitch of an external end of each slit hole in the radial direction is set substantially the same, and a pitch of an internal end thereof in the radial direction is set to be large at a central portion of the permanent magnet and is decreased as moving away from the central portion toward the end (for example, Patent Literature 1).

### PATENT LITERATURE

Patent Literature 1: Japanese Patent No. 4248984

However, according to the conventional technology described above, although devising the arrangement of the slits and the shape thereof on the surface of a magnetic pole is effective in noise reduction, an influence on demagnetization has not been taken into consideration. That is, when an electromotive force of a demagnetization phase is applied to the rotor, a magnetic flux flows into the magnet along the slits, and a local magnetic field concentrates in the permanent magnet under the slit. Therefore, partial demagnetization (an initial demagnetization stage) is likely to occur in portions adjacent to the slits of the magnet and at the end of the magnet between poles.

### SUMMARY

The present invention has been achieved to solve the above problems, and an object of the present invention is to provide a rotor for a permanent-magnet-embedded electric motor that can reduce noise while suppressing occurrence of partial demagnetization of a permanent magnet, an electric motor using the rotor, a compressor using the electric motor, and an air conditioner using the compressor.

In order to solve above-mentioned problems and achieve the object, a rotor for a permanent-magnet-embedded electric motor according to the present invention, held rotatably via an air gap on an inner peripheral face of a stator in which a plurality of teeth are arranged via a slot with equal angular intervals, centered on a shaft center, the rotor includes a rotor core formed by laminating a plurality of electromagnetic steel plates; a plurality of magnet insertion holes axially formed along an outer periphery in a circumferential direction of the rotor core with equal angular intervals, centered on a shaft center; a tabular permanent magnet inserted into the magnet insertion holes with alternating polarities, with one magnet per pole, to form a plurality of magnetic poles; and a slit hole axially formed in a vicinity of opposite ends of the magnetic pole between an outer peripheral face of the rotor core and the magnet insertion hole, and forming a symmetrical shape in an approximately truncated chevron shape along the outer peripheral face of the rotor core, based on a centerline of each of the magnetic poles, wherein a thickness of the permanent magnet is set to be twice or more of the air gap, a width of a shortest magnetic path in which a distance between the slit hole and the permanent magnet becomes shortest is set to be twice or more of the air gap, and an inclination of the slit hole with respect to a width direction of the permanent magnet orthogonal to a radial direction is set to be in a range from 0 to 30 degrees.

According to the present invention, it is possible to further reduce noise of a permanent-magnet-embedded electric motor while suppressing occurrence of partial demagnetization of a permanent magnet.

### BRIEF DESCRIPTION OF DRAWINGS

FIG. 1 is a cross-sectional view of an electric motor to which a rotor according to an embodiment of the present invention is applied.

FIG. 2 is a cross-sectional view of the rotor according to the embodiment.

FIG. 3 is an enlarged view of the vicinity of circumferential opposite ends of a magnet insertion hole.

FIG. 4 is an explanatory diagram of an inclination of a slit hole with respect to a width direction of a permanent magnet orthogonal to a radial direction.

FIG. 5 is an example of a rotor of a conventional electric motor.

FIG. 6 depicts a flow of magnetic flux when a magnetomotive force of a demagnetization phase (demagnetizing flux) is applied from a stator in the conventional rotor.

FIG. 7 depicts a flow of magnetic flux when a magnetomotive force of a demagnetization phase (demagnetizing flux) is applied from a stator in the rotor according to the embodiment.

FIG. 8 depicts a comparison result of torque ripple when the same torque is generated, in an electric motor mounted with the rotor according to the embodiment and an electric motor mounted with the conventional rotor shown in FIG. 5.

FIG. 9 depicts a comparison result of a demagnetizing factor in a permanent magnet having the same coercive force when a magnetomotive force of a demagnetization phase (demagnetizing flux) of a stator is applied to a rotor, in the electric motor mounted with the rotor according to the embodiment and the electric motor mounted with the conventional rotor shown in FIG. 5.

### DETAILED DESCRIPTION

Exemplary embodiments of a rotor for a permanent-magnet-embedded electric motor, an electric motor including the rotor, a compressor including the electric motor, and an air conditioner including the compressor according to the present invention will be explained below in detail with reference to the accompanying drawings. The present invention is not limited to the embodiments. In the following explanations, the permanent-magnet-embedded electric motor is simply referred to as “motor”, and a rotor of the electric motor is simply referred to as “rotor”.

### Embodiment

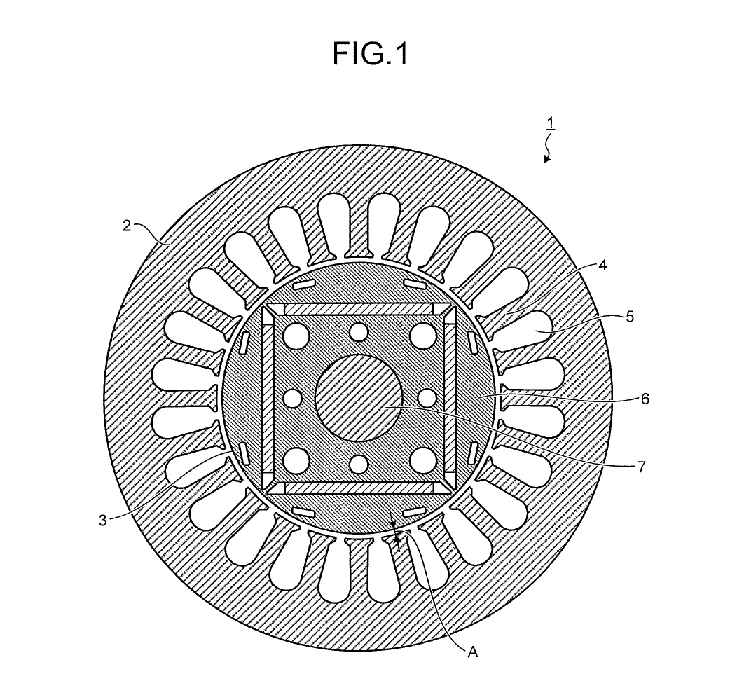

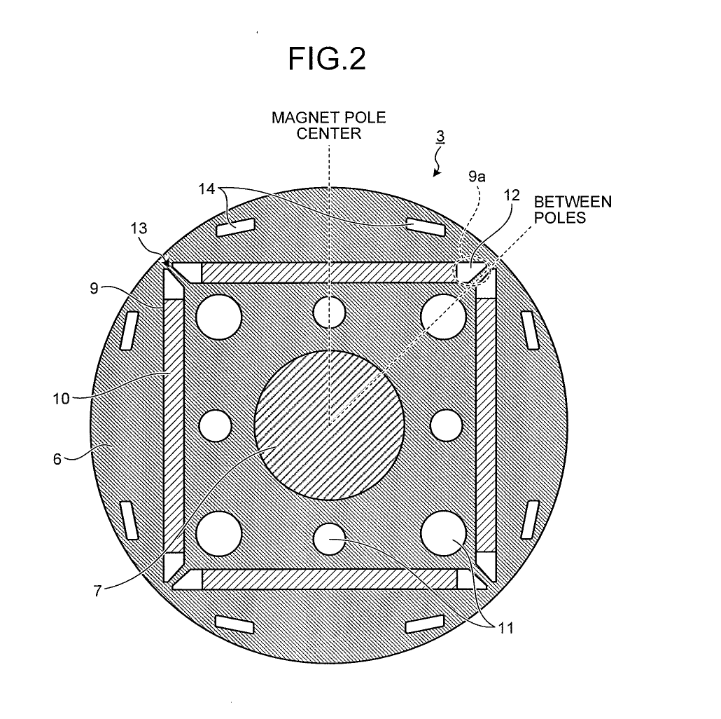

FIG. 1 is a cross-sectional view of an electric motor to which a rotor according to an embodiment of the present invention is applied. FIG. 2 is a cross-sectional view of the rotor according to the present embodiment.

As shown in FIG. 1, an electric motor 1 includes a stator 2 in which a plurality of teeth 4 wound with a stator winding wire (not shown) are arranged in a circumferential direction with equal angular intervals, centered on a shaft center via a slot 5, and a rotor 3 to which a shaft 7 for transmitting rotational energy to the shaft center of a rotor core 6 is coupled by shrinkage fitting, press fitting, or the like, and rotatably held via an air gap A between an outer peripheral face of the rotor core 6 and an inner peripheral face of the stator 2 centered on the shaft center.

As shown in FIG. 2, a plurality of magnet insertion holes 9 are formed along an outer periphery in the circumferential direction with equal angular intervals centered on the shaft center, in the axial direction of the rotor core 6. A tabular permanent magnet 10 having a thickness of about 2 millimeters and formed by, for example, a Nd—Fe—B (neodymium-iron-boron) rare-earth magnet being magnetized is inserted parallel to a thickness direction in the magnet insertion hole 9, with alternating polarities, with one magnet per pole, to form respective magnetic poles. The number of magnetic poles of the rotor 3 can be any number equal to or larger than two. However, in the example shown in FIG. 2, a case where the number of magnetic poles of the rotor 3 is four is shown. The Nd—Fe—B (neodymium-iron-boron) rare-earth magnet is used here as the permanent magnet 10. However, the type of the permanent magnet 10 is not limited thereto.

Furthermore, a plurality of through holes 11 being a refrigerant flow path are provided in the rotor core 6 in an axial direction on an inner side of the magnet insertion holes 9. The number, the position, and the shape of the through holes 11 can be other than those shown in FIG. 2.

An iron core of the stator 2 and the rotor core 6 can be constituted by forming a thin electromagnetic steel plate having a thickness of about 0.35 millimeter in a predetermined shape and laminating a predetermined number of plates.

The stator 2 is wound with a winding wire in the slot 5 of the iron core of the stator 2 via an insulating material, and an electric current having a frequency synchronized with the commanded number of rotation is applied thereto, to generate a rotating magnetic field.

In the magnet insertion hole 9, a gap 12 is formed at circumferential opposite ends 9a of the magnet insertion hole 9 at the time of inserting the permanent magnet 10 into the magnet insertion hole 9. An inner surface of the magnet insertion holes 9 centrifugally outside and inside thereof is formed by a plane along a surface of the permanent magnet 10. Although not shown, in order to arrange the permanent magnet 10 at the center of the magnetic pole of the magnet insertion hole 9 so as not to move the permanent magnet 10 in the circumferential direction, a protrusion as a stopper can be provided on an inner peripheral face of the magnet insertion hole 9 or a method such as adhesion or press fitting can be used.

An interpolar thin-wall portion 13 is formed between the adjacent gaps 12 between poles of the adjacent magnet insertion holes 9, and it is designed such that a magnetic path becomes narrow so that the magnetic flux is not short-circuited between the adjacent magnets. The width of the interpolar thin-wall portion 13 is set to be about 0.35 millimeter in this case, which is approximately the same as the electromagnetic steel plate constituting the iron core of the stator 2 and the rotor core 6.

Elongated and substantially rectangular slit holes 14 having a width (in a thinner direction) of about 1 to 2 millimeters and forming a symmetrical shape in an approximately truncated chevron shape along the outer peripheral face of the rotor core 6, based on a centerline of each of the magnetic poles, are axially formed in the vicinity of opposite ends of the magnetic pole between the outer peripheral face of the rotor core 6 and the magnet insertion hole 9. The shape of the slit hole 14 is not limited thereto, and can be in an elongated track shape.

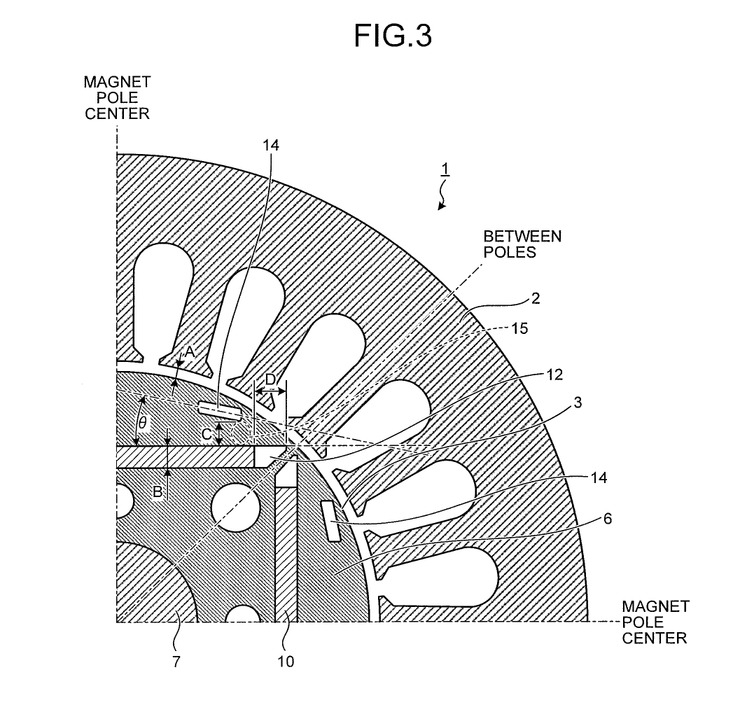

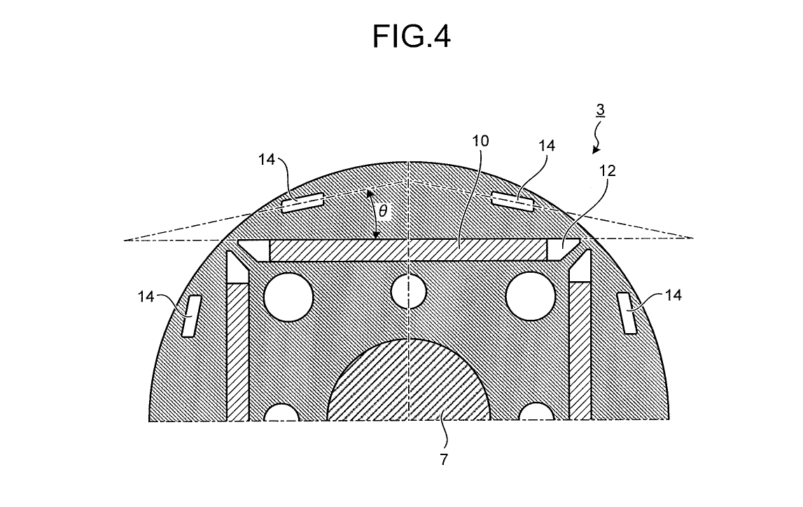

FIG. 3 is an enlarged view of the vicinity of circumferential opposite ends of the magnet insertion hole. FIG. 4 is an explanatory diagram of an inclination of the slit hole with respect to a width direction of the permanent magnet orthogonal to a radial direction.

According to the present embodiment, as shown in FIG. 3, a thickness B of the permanent magnet 10 is set to be twice or more of the air gap A (B>2A), and a width C of a shortest magnetic path 15 in which a distance between the slit hole 14 and the permanent magnet 10 becomes shortest is set to be twice or more of the air gap A (C>2A).

According to the present embodiment, as shown in FIG. 4, an inclination A of the slit hole 14 with respect to the width direction of the permanent magnet 10 orthogonal to the radial direction is in a range from 0 to 30 degrees.

Furthermore, according to the present embodiment, as shown in FIG. 3, a width D of the gap 12 in the width direction of the permanent magnet 10 orthogonal to the radial direction is set to be twice or more of the air gap A (D>2A).

An operation of the rotor according to the present embodiment is explained next with reference to FIG. 3 and FIGS. 5 to 7.

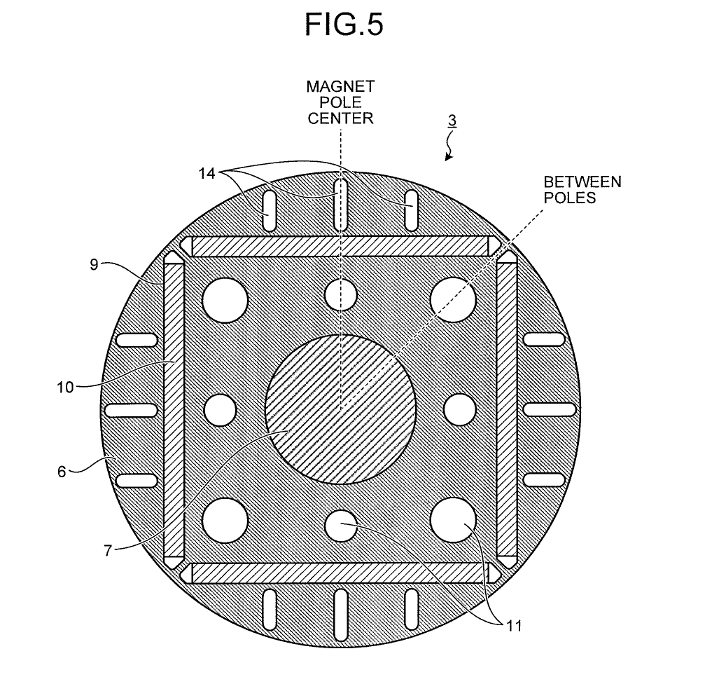

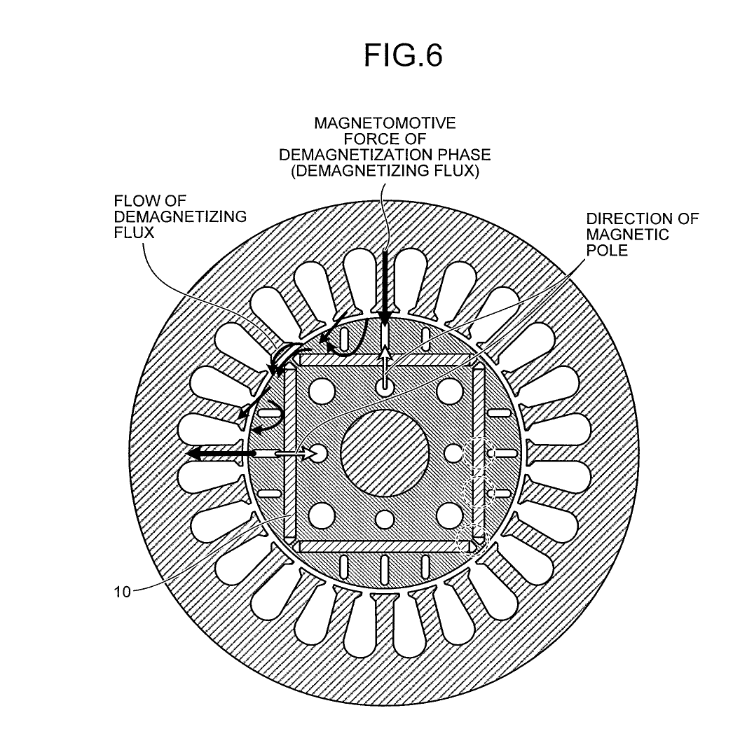

FIG. 5 is an example of a rotor of a conventional permanent-magnet-embedded electric motor. In the conventional rotor 3 shown in FIG. 5, an example in which the slit holes 14 are provided in a direction substantially vertical to the width direction of the permanent magnet 10 orthogonal to the radial direction is shown. FIG. 6 depicts a flow of magnetic flux when a magnetomotive force of a demagnetization phase (demagnetizing flux) is applied from a stator in the conventional rotor. The demagnetization phase represents an energization phase of the stator so that a magnetic field is generated in a direction opposite to the direction of the magnetic pole of the rotor 3.

As shown in FIG. 6, the demagnetizing flux applied from the stator flows into the permanent magnet 10 along the slit hole 14, passes between the slit hole 14 and the permanent magnet 10, passes through an interpolar portion in the vicinity of the circumferential opposite ends 9a of the magnet insertion hole 9, and passes through the surface of the adjacent magnetic pole to return to the stator. In the conventional rotor 3 shown in FIG. 5, partial demagnetization (an initial demagnetization stage) is likely to occur between the permanent magnet 10 and the slit holes 14 surrounded by a broken-line circle shown in FIG. 6 and in the interpolar portion in the vicinity of the circumferential opposite ends 9a of the magnet insertion hole 9.

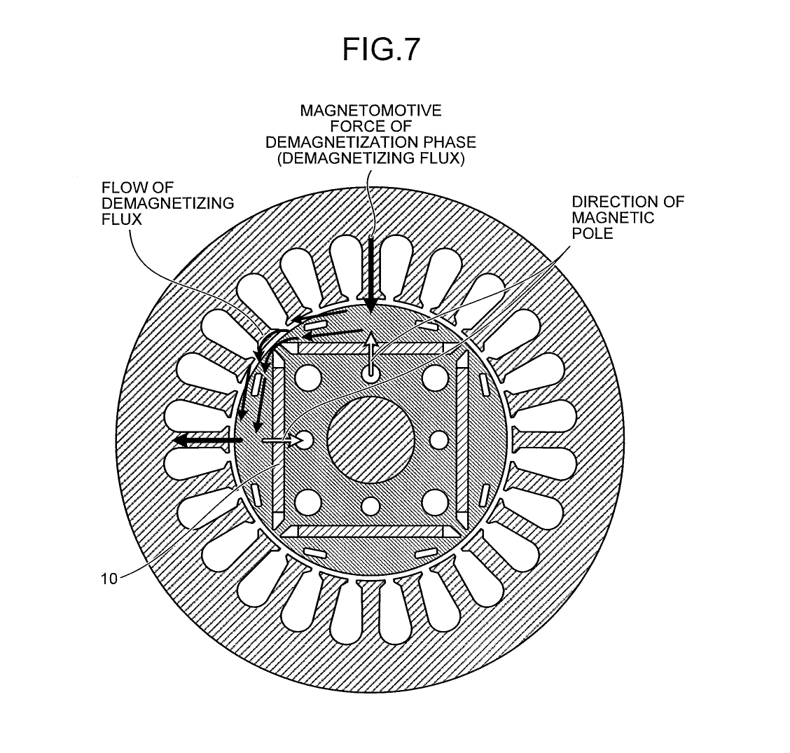

FIG. 7 depicts a flow of magnetic flux when a magnetomotive force of a demagnetization phase (demagnetizing flux) is applied from the stator in the rotor according to the present embodiment. According to the present embodiment, as shown in FIG. 3, the thickness B of the permanent magnet 10 is set to be twice or more of the air gap A (B>2A), and magnetic resistance of the permanent magnet 10 in a thickness direction is set to be twice or more of the magnetic resistance of the air gap. Therefore, as shown in FIG. 7, the demagnetizing flux having passed through the shortest magnetic path 15 can easily pass to the surface of the adjacent magnetic pole via the air gap without passing through the permanent magnet 10.

When the applied demagnetizing flux increases and the shortest magnetic path 15 is magnetically saturated, the demagnetizing flux is to flow into portions other than the shortest magnetic path 15. According to the present embodiment, as shown in FIG. 3, the width C of the shortest magnetic path 15 is set to be twice or more of the air gap A (C>2A), so that the demagnetizing flux hardly passes through the permanent magnet 10. Therefore, in a state where the shortest magnetic path 15 is magnetically saturated, the magnetic flux is short-circuited via the air gap, or passes an inside area within about twice the air gap A from the outer peripheral side of the rotor 3 having small magnetic resistance. That is, by setting the width C of the shortest magnetic path 15 to twice or more of the air gap A (C>2A), the magnetic resistance between the slit hole 14 and the permanent magnet 10 when the shortest magnetic path 15 is magnetically saturated is set to be twice or more of the magnetic resistance of the air gap. Accordingly, even when the shortest magnetic path 15 is magnetically saturated, the permanent magnet 10 is hardly demagnetized.

According to the present embodiment, occurrence of partial demagnetization is suppressed by causing the demagnetizing flux to pass through the shortest magnetic path 15. However, as in the conventional example shown in FIG. 5, when the slit holes 14 are provided in a direction substantially vertical to the width direction of the permanent magnet 10 orthogonal to the radial direction, there are less paths of the demagnetizing flux other than the shortest magnetic path 15. Therefore, the demagnetizing flux locally concentrates on the shortest magnetic path 15, and the adjacent permanent magnets 10 may be demagnetized.

Therefore, according to the present embodiment, as shown in FIG. 3, the inclination A of the slit hole 14 with respect to the width direction of the permanent magnet 10 orthogonal to the radial direction is set to 0 to 30 degrees. As shown in FIG. 7, the magnetic path between the slit holes 14 and the outer peripheral face of the rotor 3 is used to bypass the demagnetizing flux.

It is preferable that the inclination θ of the slit hole 14 is parallel to the width direction of the permanent magnet 10 orthogonal to the radial direction in order to suppress occurrence of demagnetization. However, in order to reduce torque ripple due to harmonic components of an induced voltage and suppress generation of noise due to the torque ripple, it is desired that a magnetic flux density has a sinusoidal waveform such that the magnetic flux density is largest at the center of the magnetic pole, an amount of change in the magnetic flux density gradually increases from the center of the magnetic pole toward the interpolar portion, and the magnetic flux density becomes a value close to 0T in the interpolar portion. To approximate the magnetic flux density on the surface of the rotor 3 to a sinusoidal waveform, it is preferable to incline the slit hole 14 slightly with the inclination θ. Accordingly, by setting the inclination θ of the slit to be in a range from 0 to 30 degrees, designing taking into consideration both noise reduction and suppression of occurrence of demagnetization can be realized.

It is preferable that the slit hole 14 is arranged at a position satisfying the conditions described above and in the vicinity of the circumferential opposite ends 9a of the magnet insertion hole 9 between the outer peripheral face of the rotor core 6 and the magnet insertion hole 9. Because it is desired that the magnetic flux density on the surface of the rotor 3 is distributed in a sinusoidal waveform, with a peak being at the center of the magnetic pole, the magnetic flux density on the surface of the rotor 3 can be controlled to have a sinusoidal waveform more easily by arranging the slit hole 14 in the vicinity of the circumferential opposite ends 9a of the magnet insertion hole 9 than arranging the slit hole 14 at the center of the magnetic pole.

By setting the shortest magnetic path 15 in which the distance between the slit hole 14 and the permanent magnet 10 becomes shortest as wide as possible, more magnetic flux can be caused to pass therethrough, thereby suppressing occurrence of demagnetization of the permanent magnet 10. Accordingly, the slit holes 14 can be arranged so that the magnetic flux density distribution approximates to a sinusoidal waveform and lies along the outer periphery of the rotor 3.

According to the present embodiment, by causing the demagnetizing flux to pass through the shortest magnetic path 15, partial demagnetization is suppressed. Therefore, it is preferable that there is no portion in which the magnetic path becomes partially narrow. Therefore, according to the present embodiment, as shown in FIG. 2, the inner surface of the magnet insertion holes 9 centrifugally outside is formed by a plane along the surface of the permanent magnet 10.

According to the present embodiment, as described above, by causing the demagnetizing flux to pass through the shortest magnetic path 15, occurrence of partial demagnetization is suppressed. Therefore, when the demagnetizing flux passes through the outer circumference of the rotor 3 in the interpolar portion, the demagnetizing flux can easily pass through the interpolar thin-wall portion 13, and thus facilitates flux linkage with the permanent magnet 10. Therefore, according to the present embodiment, as shown in FIG. 2, the width D of the gap 12 in the width direction of the permanent magnet 10 orthogonal to the radial direction is set to be twice or more of the air gap A (D>2A). Accordingly, the magnetic resistance in a portion from the circumferential opposite ends 9a of the magnet insertion hole 9 to the permanent magnet 10 becomes twice or more of the magnetic resistance of the air gap. Consequently, the flux linkage of demagnetizing flux with the permanent magnet 10 can be suppressed at the time of passing through the outer circumference of the rotor 3 in the interpolar portion, thereby enabling to further increase an improvement effect of demagnetization durability.

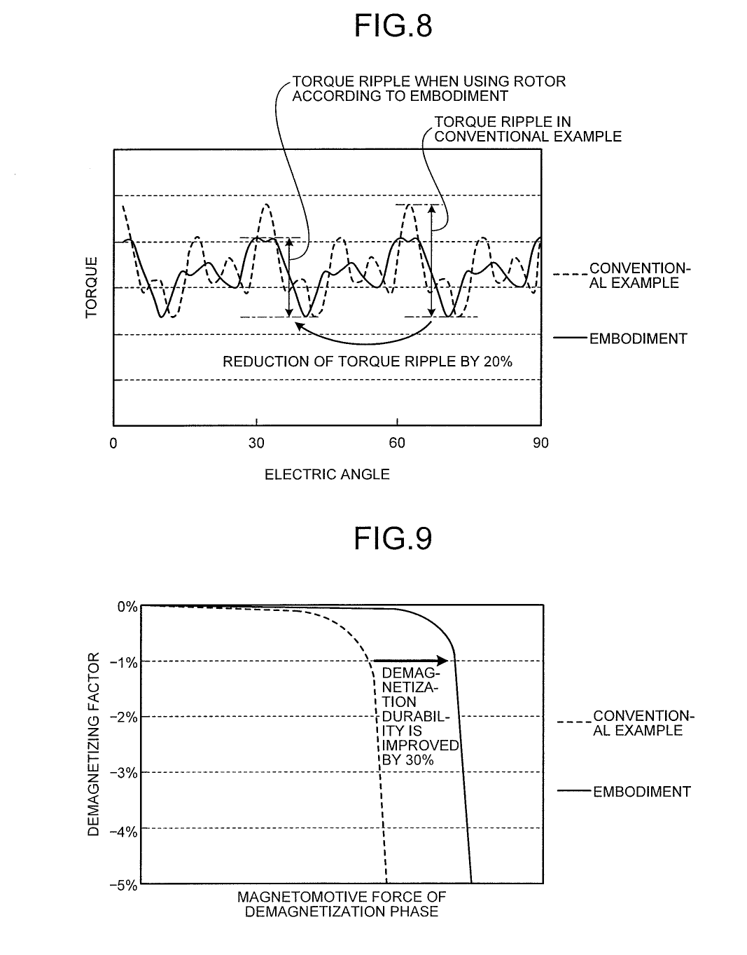

A comparison result between the conventional example shown in FIG. 5 and a case of using the rotor according to the present embodiment is explained next with reference to FIGS. 8 and 9.

FIG. 8 depicts a comparison result of torque ripple when the same torque is generated, in an electric motor mounted with the rotor according to the present embodiment and an electric motor mounted with the conventional rotor shown in FIG. 5. FIG. 9 depicts a comparison result of a demagnetizing factor in a permanent magnet having the same coercive force when a magnetomotive force of a demagnetization phase of a stator is applied to a rotor, in the electric motor mounted with the rotor according to the present embodiment and the electric motor mounted with the conventional rotor shown in FIG. 5.

In FIG. 8, the horizontal axis denotes an electric angle, and the vertical axis denotes torque. As shown in FIG. 8, in the electric motor mounted with the rotor according to the present embodiment (shown by a solid line in FIG. 8), the torque ripple can be reduced by about 20% as compared with the electric motor mounted with the conventional rotor shown in FIG. 5 (shown by a broken line in FIG. 8), and the electric motor mounted with the rotor according to the present embodiment can achieve more vibration reduction and noise reduction.

In FIG. 9, the magnetomotive force of the demagnetization phase on the horizontal axis uses a phase magnetomotive force obtained by multiplying a conduction current by the number of turns of the phase winding as an index, and the demagnetizing factor on the vertical axis uses a change in a magnetic flux generated by the rotor before and after the magnetomotive force is applied as an index.

When the electric motor is demagnetized, the performance of a compressor mounted with the electric motor or an air conditioner using the compressor fluctuates. Furthermore, because a voltage generated in the electric motor changes, the controllability of the electric motor is deteriorated. A decrease in the demagnetizing factor needs to be suppressed to about 1% in order to satisfy the reliability of the product as compared to the electric motor mounted with the conventional rotor shown in FIG. 5 (shown by a broken line in FIG. 8).

As shown in FIG. 9, in the electric motor mounted with the rotor according to the present embodiment (indicated by a solid line in FIG. 9), the magnetomotive force having a demagnetizing factor of 1% can be increased by about 30% as compared to the electric motor mounted with the conventional rotor shown in FIG. 5 (shown by a broken line in FIG. 5).

That is, when the magnetomotive force having the demagnetizing factor of 1% is at the same level, the electric motor mounted with the rotor according to the present embodiment is more durable in use in a high-temperature environment than the electric motor mounted with the conventional rotor.

When the electric motors are used in the same current range and under the same temperature condition, the electric motor mounted with the rotor according to the present embodiment can use a magnet having a lower coercive force than the electric motor mounted with the conventional rotor. That is, an additive amount of a heavy rare-earth element such as Dy (dysprosium) or Tb (terbium) for improving the coercive force can be reduced, thereby realizing cost reduction of the electric motor.

The electric motor using the rotor according to the present embodiment can perform a highly efficient operation matched with required product load conditions by performing variable speed drive by PWM control using an inverter of a drive circuit.

When the electric motor using the rotor according to the present embodiment is mounted on, for example, a compressor of an air conditioner, the permanent magnet of the rotor is hardly demagnetized. Accordingly, a compressor more durable in use in a high-temperature environment (for example, 100° C. or higher) can be acquired.

As explained above, according to the rotor of the permanent-magnet-embedded electric motor of the present embodiment, the elongated and substantially rectangular slit holes forming a symmetrical shape in an approximately truncated chevron shape along the outer peripheral face of the rotor core, based on a centerline of each of the magnetic poles, are formed in the vicinity of circumferential opposite ends of the magnet insertion hole between the outer peripheral face of the rotor core and the magnet insertion hole. Consequently, occurrence of partial demagnetization of the permanent magnet is suppressed, thereby acquiring a highly reliable electric motor. Further, harmonic components of the induced voltage are suppressed to reduce torque ripple of the electric motor, and further reduction in vibration and noise can be realized.

More specifically, by setting the thickness B of the permanent magnet to twice or more of the air gap A (B>2A), and by setting the magnetic resistance of the permanent magnet in the thickness direction to twice or more of the magnetic resistance of the air gap, the demagnetizing flux having passed through the shortest magnetic path in which the distance between the slit hole and the permanent magnet becomes shortest can easily pass through the surface of the adjacent magnetic pole via the air gap without passing through the permanent magnet, and thus the permanent magnet is hardly demagnetized.

By setting the width C of the shortest magnetic path to twice or more of the air gap A (C>2A), and setting the magnetic resistance between the slit hole and the permanent magnet when the shortest magnetic path is magnetically saturated to twice or more of the magnetic resistance of the air gap, the permanent magnet is hardly demagnetized even when the shortest magnetic path is magnetically saturated.

It is desired that an amount of change in the magnetic flux density has a sinusoidal waveform so that the magnetic flux density gradually increases from the center of the magnetic pole toward the interpolar portion and becomes a value close to 0T in the interpolar portion. By setting the inclination θ of the slit hole with respect to the width direction of the permanent magnet orthogonal to the radial direction to be in a range from 0 to 30 degrees so that the magnetic flux density on the surface of the rotor approximates to a sinusoidal waveform, designing taking into consideration both noise reduction and suppression of occurrence of demagnetization can be realized.

By forming the inner surface of the magnet insertion hole centrifugally outside in a flat surface along the surface of the permanent magnet, a portion in which the magnetic path becomes partially narrow to cause partial demagnetization can be eliminated.

Furthermore, by setting the width D of the gap in the width direction of the permanent magnet orthogonal to the radial direction to twice or more of the air gap A (D>2A), to set the magnetic resistance in the portion from the circumferential opposite ends of the magnet insertion hole to the permanent magnet to twice or more of the magnetic resistance of the air gap, the flux linkage of demagnetizing flux with the permanent magnet can be suppressed at the time of passing through the outer circumference of the rotor in the interpolar portion. Accordingly, the improvement effect of the demagnetization durability can be increased.

Because the permanent magnet is hardly demagnetized, a permanent magnet having a low coercive force can be used. When the permanent magnet is used at a high temperature, an additive amount of a heavy rare-earth element used for improving the coercive force of the permanent magnet can be reduced, thereby realizing cost reduction of the electric motor.

Further, when the rotor according to the present embodiment is applied to an electric motor, both improvement in reliability and noise reduction of the rotor can be realized by suppressing demagnetization of the permanent magnet. A highly efficient operation matched with required product load conditions can be performed by performing variable speed drive by a PWM control using an inverter of a drive circuit.

By applying the electric motor described above to a compressor, both improvement in reliability and noise reduction of the rotor can be realized by suppressing demagnetization of the permanent magnet, thereby enabling to perform a highly efficient operation matched with required product load conditions.

By applying the compressor described above to an air conditioner, improvement of the reliability and noise reduction of the rotor can be realized by suppressing demagnetization of the permanent magnet, thereby enabling to perform a highly efficient operation matched with the required product load conditions.

The effects of the rotor for the permanent-magnet-embedded electric motor according to the above embodiment, an electric motor including the rotor, a compressor including the electric motor, and an air conditioner including the compressor can be exerted regardless of the winding method, the number of slots, and the number of poles.

The configuration described in the above embodiment is only an example of the configuration of the present invention. The configuration can be combined with other well-known techniques, and it is needless to mention that the present invention can be configured while modifying it without departing from the scope of the invention, such as omitting a part of the configuration.

1. A rotor for a permanent-magnet-embedded electric motor, rotatably held on an inner peripheral face of a stator, the rotor comprising:
a rotor core formed by laminating a plurality of electromagnetic steel plates;
a plurality of magnet insertion holes formed along an outer periphery in a circumferential direction of the rotor core;
tabular permanent magnets inserted into the magnet insertion holes with alternating polarities, to form a plurality of magnetic poles; and
elongated slit holes each formed in the vicinity of opposite ends of the magnetic pole between an outer peripheral face of the rotor core and the magnet insertion hole wherein
an inclination of a longitudinal axis of each of the slit holes opened towards a center of the magnetic pole with respect to a width direction of the permanent magnet is set to be in a range from 0 to 30 degrees, and a magnetic path between the outer peripheral face of the rotor core and the slit hole extends toward a center side of the magnetic pole.

2. The rotor for a permanent-magnet-embedded electric motor according to claim 1, wherein
the magnet insertion hole is formed such that a gap is formed at circumferential opposite ends of the magnet insertion hole at the time of inserting the permanent magnet therein, and
a width of the gap in the width direction of the permanent magnet orthogonal to the radial direction is set to be twice or more of the air gap.

3. The rotor for a permanent-magnet-embedded electric motor according to claim 1, wherein the permanent magnet is a rare-earth magnet.

4. (canceled)

5. The rotor for a permanent-magnet-embedded electric motor according to claim 1, wherein the magnet insertion hole is formed so that an inner surface thereof centrifugally outside becomes a flat surface along the surface of the permanent magnet.

6. The rotor for a permanent-magnet-embedded electric motor according to claim 5, wherein the magnet insertion hole is formed so that an inner surface thereof centrifugally outside becomes a flat surface along the surface of the permanent magnet.

7. (canceled)

8. (canceled)

9. An electric motor comprising the rotor for a permanent-magnet embedded electric motor according to claim 1.

10. A compressor comprising the electric motor according to claim 9.

11. An air conditioner comprising the compressor according to claim 10.

12. The rotor for a permanent-magnet-embedded electric motor according to claim 1, wherein a thickness of the permanent magnet is set to be twice or more of an air gap between the outer peripheral face of the rotor core and the inner peripheral face of the stator, and a width of a shortest magnetic path in which the distance between the slit hole and the permanent magnet becomes shortest is set to be twice or more of the air gap.
